(19) United States
(12) Patent Application Publication
(10) Pub. No.: US 2002/0196859 A1
(43) Pub. Date: Dec. 26, 2002

(54) Method of performing bit modeling and circuit that uses this method

(76) Inventor: Masahiro Taniguchi, Tokyo (JP)

Correspondence Address: Platon N. Mandros, BURNS, DOANE, SWECKER & MATHIS, L.L.P., P.O. BOX 1404, Alexandria, VA, 22313-1404, US

(21) Appl. No.: 10/028,320

(22) Filed: Dec. 28, 2001

(30) Foreign Application Priority Data
Jun. 26, 2001 (JP) 2001-192670

(51) Int. Cl. H04B 14/04; H04N 7/30

(52) U.S. Cl. 375/253

(57) ABSTRACT

A processing circuit of bit modeling simultaneously generates contexts and decisions which change according to a state of significance flags of a bit to be processed and ambient bit group and a state of a sign bit with a sig pass, adopts the context and the decision of the sign bit only when a value of the bit to be processed is 1 so as to update the significance flag, disposes of the context and the decision when the value of the bit to be processed is 0, and updates the processed flag whether the value of the bit to be processed is 1 or 0. The processing circuit is simultaneously applied to bits O0 to O3 in one group so as to process the bits in parallel.

### FIELD OF THE INVENTION

This invention relates to a method of performing bit modeling and a circuit that uses this method. More specifically, the invention relates to a method of performing bit modeling relating to heightening of a speed of the bit modeling in coding of JPEG 2000 and a circuit that uses this method.

### BACKGROUND OF THE INVENTION

In a coding process of JPEG 2000 (defined by ISO/IEC FDIS15444-1. Hereinafter, referred to as JPEG 2000), a quantization coefficient is represented by a sign bit and an absolute value. As for bits representing the absolute value in a code block unit, while up-and-down and right-and-left relationships of the bits are being checked in the order from high-order bit plane to low-order bit plane, context and decision are generated. This will be referred to as bit modeling.

When N0-numbered bit planes where all the bits are zero continue from the highest-order bit plane representing the absolute value in the code block, the process is executed separately.

For example, the absolute value is accuracy of M bit planes, and when the high-order N0 bits of all absolute values are zero in a certain code block, only bit planes of N=M−N0 is subject to bit modeling.

The highest-order bit plane being subject to bit modeling is called as MSB (Most Significant Bit plane), and the lowest-order bit plane is called as LSB (Less Significant Bit plane).

Data in the code block are processed in each bit plane from MSB to LSB. In each bit plane, four bits in a vertical direction make one group and are subject to the bit modeling in a raster order.

FIG. 14 shows the order (0 to 23) that the group is processed when the bit modeling is carried out in the code block size of horizontal 8 (0 to 7)×vertical 12 (0 to 11).

In addition, FIG. 15 shows the processing order (0 to 7) of the respective bits across the group in the bit plane (four bits in the vertical direction, for example, horizontal 0×vertical 4 (0 to 3), horizontal 1×vertical 4 (0 to 3)).

The bit modeling has three kinds of coding passes: significance propagation decoding pass (hereinafter, referred to as sig pass); magnitude refinement pass (hereinafter referred to as ref pass); and cleanup pass (hereinafter, cln pass). The process is executed in the order of the sig pass, the ref pass and the cln pass.

Namely, in this process, the bits in a certain bit plane are evaluated in the order shown in FIGS. 14 and 15, and when that data should be processed with the sig pass, they are processed with the sig pass, and when not, the process proceeds to the next bit.

When the code block process is ended, the bits are evaluated as the ref pass. Finally, the bits are processed with the cln pass. At this time, when a certain bit is processed with the coding pass in the early processing order (priority is high), the bit is not processed with another coding passes.

Therefore, the bits are processes are processed with only one of the three kinds of the coding passes. This process is repeated from MSB to LSB, but only MSB is processed with the cln pass.

For example, when N=8, a bit modeling operation that (7 bit planes×3 coding passes+1 coding pass)×(8×12) code block size is necessary.

In the aforementioned conventional processing method of JPEG 2000 bit modeling, for example, when a certain code block is subject to bit modeling, one datum requires a process which is (N−1)×3+1 times according to the bit plane to be processed.

This creates a problem that the processing speed decreases in comparison with quantization or the like which requires only one process regardless of bit accuracy.

### SUMMARY OF THE INVENTION

The method of performing bit modeling and a circuit that uses the method according to the present invention, in a processing method of JPEG 2000 bit modeling with a significance propagation decoding pass, a processing circuit of bit modeling simultaneously generates a context and a decision of data changing according to a state of significance flags of a bit to be processed and ambient bit group and a context and a decision of sign bits changing according to a state of the sign bits of the bit to be processed and the ambient bit group, adopts the context and decision of the sign bits only when a value of the bit to be processed is 1 and updating the significance flag, disposes of the context and the decision when the value of the bit to be processed is 0, and updates a processed flag whether the value of the bit to be processed is 1 or 0. The processing circuit is simultaneously applied to four bits in one group and processes the four bits in parallel.

In addition, in a processing method of JPEG 2000 bit modeling with a magnitude refinement pass, a processing circuit of the bit modeling refers to significance second bit which is information about as to whether or not a bit to be processed is processed with the magnitude refinement pass at first time, a processed flag and an significance flag so as to make a judgment as to whether or not the bit to be processed is processed, and in the case where the bit to be processed is processed with the magnitude refinement pass, generates a context and a decision of the bit so as to update the processed flag. The processing circuit is simultaneously applied to four bits in one group and processes the four bits in parallel.

In addition, in a processing method of JPEG 2000 bit modeling with a cleanup pass, a first processing circuit for the bit modeling, when all bits in Annie group to be processed are unprocessed, making a judgment as to whether or not the bits can be processed collectively and when all the bits in the group are insignificant, generating a special context and a decision, and a second circuit of the bit modeling for not processing processed bits and processing insignificant bits are provided. The first processing circuit is applied to one bit and the second processing circuit is applied to four bits in the group simultaneously so as to process the bits in parallel.

In addition, in a processing method of JPEG 2000 bit modeling, one bit plane is processed with three kinds of coding passes successively.

In addition, in a processing method of JPEG 2000 the bit modeling, three adjacent groups in one bit plane are processed with three kinds of coding passes in parallel.

In addition, in the processing method of the bit modeling from the fifth aspect, a plurality of bits in the bit plane are processed in parallel.

In addition, in the processing method of the bit modeling from the fifth or sixth aspect, a plurality of bit planes are processed in parallel.

In addition, a processing circuit using the processing method of the bit modeling from the first aspect, includes: a register for storing a value of data of a bit to be processed; a register for storing significance flags and sign bits of the bit to be processed and ambient bit group; and a register for storing an unprocessed flag of the bit to be processed.

In addition, a processing circuit using the processing method of the bit modeling from the second aspect, includes: a register for storing a value of data of a bit to be processed; a register for storing significance flags of the bit to be processed and ambient bit group; and a register for storing a significance second bit which is information about as to whether or not the bit to be processed is processed with the magnitude refinement pass at the first time.

In addition, a processing circuit using the processing method of the bit modeling from any one of the fifth, sixth or eighth aspect, includes a register for storing data bits, sign bits, processed flags, significance flags and significance second bits for a code block size.

Further, a processing circuit using the processing method of the bit modeling from any one of the fifth, sixth or eighth aspect, includes a register for storing a data bit, a sign bit, a processed flag, a significance flag and a significance second bit for a bit to be processed.

Other objects and features of this invention will become apparent from the following description with reference to the accompanying drawings.

### BRIEF DESCRIPTION OF THE DRAWINGS

FIG. 1 is a diagram showing a range of data to be used in the case where a certain group is processed in bit modeling of JPEG 2000 according to a first embodiment of the present invention;

FIG. 2 is a diagram showing a range of data to be used in the case where a bit O0 is processed in the bit modeling of JPEG 2000 according to the first embodiment of the present invention;

FIG. 3 is a diagram showing a range of data to be used in the case where a bit O1 is processed in the bit modeling of JPEG 2000 according to the first embodiment of the present invention;

FIG. 4 is a diagram showing a range of data to be used in the case where a bit O2 is processed in the bit modeling of JPEG 2000 according to the first embodiment of the present invention;

FIG. 5 is a diagram showing a range of data to be used in the case where a bit O3 is processed in the bit modeling of JPEG 2000 according to the first embodiment of the present invention;

FIG. 6 is a diagram showing a range of data to be used in the case where three continued groups are processed according to a fifth embodiment of the present invention;

FIG. 7 is a diagram showing a range of data to be used in the case where a bit group O8 to O11 according to the fifth embodiment of the present invention;

FIG. 8 is a diagram showing a range of data to be used in the case where a bit group O4 to O7 according to the fifth embodiment of the present invention;

FIG. 9 is a diagram showing a range of data to be used in a bit group O0 to O3 according to the fifth embodiment of the present invention;

FIG. 10 is a diagram showing values of data to be processed which are divided into a code bit and data for each bit plane in the bit modeling of JPEG2000 according to a sixth embodiment of the present invention;

FIG. 11 is a diagram showing values of data to be subject to another process which are divided into a code bit and data for each bit plane in the bit modeling of JPEG2000 according to the sixth embodiment of the present invention;

FIG. 12 is a diagram showing values of data to be subject to still another process which are divided into a code bit and data for each bit plane in the bit modeling of JPEG2000 according to the sixth embodiment of the present invention;

FIG. 13 is a diagram showing a range of data to be used in the case where three continued groups are processed in parallel according to a seventh embodiment of the present invention;

FIG. 14 is a diagram showing an order of groups to be processed within bit plane in a conventional bit modeling of the JPEG2000; and

FIG. 15 is a diagram showing an order of groups to be processed within another bit plane in the conventional bit modeling of JPEG2000.

### DESCRIPTION OF THE PREFERRED EMBODIMENTS

Embodiments of the method and circuit according to the present invention will be explained below while referring to the accompanying drawings.

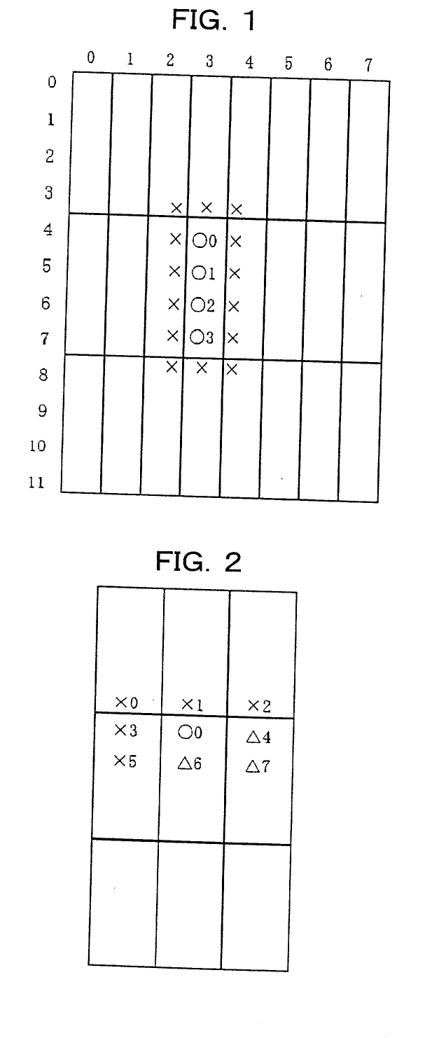

FIG. 1 is a diagram showing the case where a bit group of O0 to O3 in a certain bit plane of JPEG 2000 according to a first embodiment is processed. When the bit group of O0 to O3 is processed with a sig pass, information about bits represented by x in ambient bits is required.

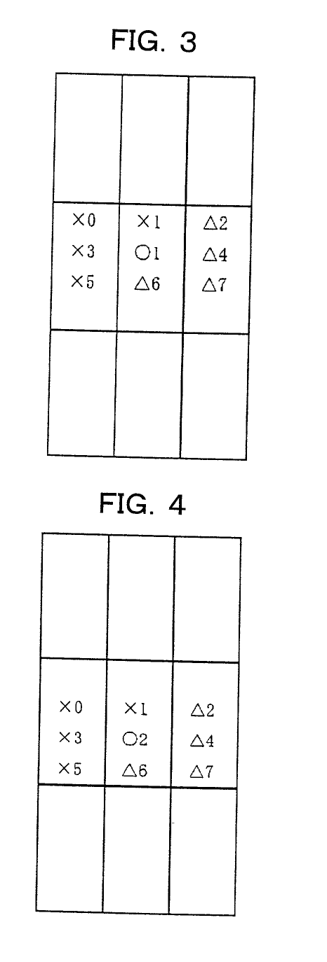

FIG. 2 is a diagram showing bits that are required when the bit O0 in FIG. 1 is processed. In FIG. 2, x0, x1, x2, x3 and x5 are bits which are processed with the same coding pass before the bit O0. Moreover, Δ4, Δ6 and Δ7 are bits which are processed after the bit O0.

A condition that a bit is to be processed with the sig pass is that the bit is insignificance and ambient bits are composed of one or more significant bits.

Therefore, information about whether or not the bit to be processed and the ambient bits are significant (hereinafter, referred to as significance flags) is required. The significance flags are stored in a register.

When the bit O0 is insignificant and the ambient bit group of xO to Δ7 include one or more significant bits, the bit is processed with the sig pass.

A context (hereinafter data context) is generated according to the state of the significance flag of the ambient bit groups of x0 to Δ7, and the value of the bit O0 itself is determined as a decision (hereinafter, data decision)

When the value of the bit O0 is 1, the data is changed from insignificance to significance. For this reason, the significance flag is updated, and the sign bit is also subject to the bit modeling.

The sign bit process requires a sign bit of the bit O0 and sign bits of the ambient bit group of x0 to Δ7.

A context (hereinafter, sign bit context) is generated according to the state of the sign bits of the ambient bit group of x0 to Δ7, and a result of an XOR operation of values according to the sign bit of the bit O0 and the context is determined as a decision (hereinafter, sign bit decision)

The context and the decision of the data and the context and the decision of the sign bit are generated simultaneously. Only when necessary (when the value of the bit O0 is 1), the context and the decision of the sign bit is adopted.

In addition, when not necessary (the value of the bit O0 is 0), the context and the decision are disposed of so that the process can be executed in parallel.

In addition, even though the value of the bit O0 is 1 or 0, when the bit O0 is processed with the sig pass, information that shows “processed” in that bit plane (hereinafter, processed flag) is updated.

When a certain bit is processed by the sig pass, the value of the bit, the significance flags and the sign bits of the bit and the ambient bits are referred to.

Namely, a register, in which the value of the bit O0, the significance flag of the bit O0 and the ambient bit group of x0 to Δ7 and the sign bits are stored, is required.

In addition, a register in which the processed flag of the bit O0 should be prepared.

FIG. 3 is a diagram showing bits that are required when the bit O1 shown in FIG. 1 is processed. With reference to FIG. 3, as for a judgment as to whether or not the bit O1 is processed with the sig pass, the significance flag of the ambient bit group of x0 to Δ7 are referred to.

In addition, since the significance flag of the bit x1 is equal with the significance flag of the bit O0 shown in FIG. 2, it is possibly updated at the time of processing the bit O0. For this reason, the process on the bit O1 cannot be started until the process on the bit O0 is ended. However, when the bit O1 is processed, if it is understood as to whether or not the significance flag of the bit x1 is updated, the processes on the bit O1 and the bit O0 can be executed simultaneously.

Namely, when the bit x1 is insignificant and its value is 1 and the ambient bit group includes one or more significant bits, a judgment is made that the bit x1 becomes significant at a previous process with the sig pass. The significance flags of the bit x1 and the ambient bit group and the value of the bit are referred to simultaneously so that the significance flag is updated. As a result, the bit O0 and the bit O1 are processed simultaneously.

FIG. 4 is a diagram showing bits that are required when the bit O2 shown in FIG. 1 is processed. With reference to FIG. 4, as for a judgment as to whether or not the bit O2 is processed with the sig pass, significance flag of the ambient group of x0 to Δ7 are referred to.

Since the significance flag of the bit x1 is equal with the significance flag of the bit O1 shown in FIG. 3, the significance flag of the bit x1 is possibly updated at the time of processing the bit O1. The process on the bit O2 cannot be started until the process on the bit O1 is ended. However, when the bit O2 is processed, if it is understood as to whether or not the significance flag of the bit x1 is updated, the bit O1 and O2 can be processed simultaneously.

Namely, when the bit x1 is insignificant and its value is 1 and the ambient bit group includes one or more significant bits, a judgment is that the bit x1 becomes significant at a previous process with the sig pass. The significance flags of the bit x1 and the ambient bit group and the value of the bit are referred to simultaneously so that x1 is updated to the significance flag. As a result, the bit O1 and the bit O2 are processed simultaneously.

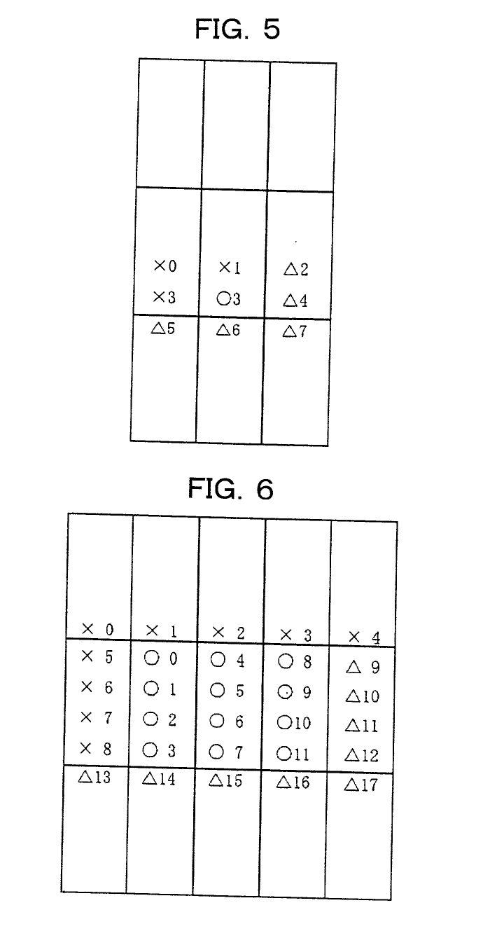

FIG. 5 is a diagram showing bits that are required when the bit O3 shown in FIG. 1 is processed. With reference to FIG. 5, as for a judgment as to the bit O3 is processed with the sig pass, the significance flag of the ambient bit group of x0 to Δ7 are referred to.

Since the significance flag of the bit x1 is equal with the significance flag of the bit O2 shown in FIG. 4, the significance flag of the bit x1 is possibly updated at the time of processing the bit O2. The process on the bit O3 cannot be started until the process on the bit O2 is ended. However, when the bit O3 is processed, if it is understood as to whether or not the significance flag of the bit x1 is updated, the bit O2 and the bit O3 can be processed simultaneously.

Namely, when the bit x1 is insignificant and its value is 1 and the ambient bit group includes one or more significant bits, a judgment is made that the bit x1 becomes significant at a previous process with the sig pass. The significance flags of the bit x1 and the ambient bit group and the value of the bit are referred to simultaneously so that the bit x1 is updated to the significance flag. As a result, the bit O2 and the bit O3 are processed simultaneously.

According to the first embodiment, a circuit can be configured so as to be capable of executing the parallel process on the bit group of O0 to O3, and making the judgment as to whether or not the data of 1 bit are processed with the sig pass, and outputting zero, one or two sets of the contexts and the decisions.

In addition, four circuits which process data of 1 bit are arranged in parallel so as to process the bits O0, O1, O2 and O3 respectively. As a result, the circuit which outputs 0 to 8 sets of contexts and decisions for one group (four data) can be configured.

There will be explained below the parallel processing method according to a second embodiment. In the second embodiment the bits shown in FIG. 1 to FIG. 5 are processed with a ref pass. Therefore, the second embodiment will be explained while referring to FIG. 1 to FIG. 5.

At first, when the bit group of O0 to O3 shown in FIG. 1 is processed with the ref pass, information about bits represented by x in the ambient group is required. When the group is classified according to the respective bits, information about ambient 8 bits is required for the bits O0, O1, O2 and O3 shown in FIG. 2 to FIG. 5.

The condition that a bit is processed with the ref pass is that the bit should not be processed with the sig pass and should be significant. Therefore, information showing as to whether or not the bit to be processed is processed and significant is required.

When the bit O0 shown in FIG. 2 is unprocessed and significant, it is to be processed with the ref pass. When the bit O0 is processed with the ref pass at the first time, data context is generated according to the state of the significance flag of the ambient bit group of x0 to Δ7. When it is not processed with the ref pass at the first time, fixed data context is generated regardless of the state of the significance flag.

When both the cases, the value of the bit O0 itself is the data decision. When the bit O0 is processed with the ref pass, the processed flag is updated, and the significance flag and the processed flag which are the same as the sig pass are used. Further, information about as to whether or not the bit O0 is processed with the ref pass at the first time (hereinafter, referred to as significance second bit) is stored in a register.

In FIG. 3, as for a judgment as to whether or not the bit O1 is processed with the ref pass, the processed flag and the significance flag of the bit O1 are referred to. Similarly in FIGS. 4 and 5, the processed flag and the significance flag of the bit O2 and the bit O3 are referred to.

In addition, in order to process the bits O0, O1, O2 and O3 shown in FIG. 2 to FIG. 5, the values of the bit group of O0 to O3 shown in FIG. 1, the processed flag and the significance flag, and the significance flag of the bits O and the bits x are required.

According to the second embodiment, since the ref pass does not update the significance flag, a circuit can be configured so as to be capable of executing the parallel process on the bit groups of O0 to O3, making a judgment as to whether or not the data of 1 bit are processed with the ref pass and outputting 0 or one set of context and decision.

In addition, four circuits for processing the data of 1 bit are arranged in parallel so as to process the bits O0, O1, O2 and O3 respectively. As a result, the circuit which outputs 0 to 4 sets of contexts and decisions for one group (four data) can be configured.

There will be explained below the parallel processing method according to a third embodiment. In the second embodiment the bits shown in FIG. 1 to FIG. 5 are processed with a cln pass. Therefore, the second embodiment will be explained while referring to FIG. 1 to FIG. 5.

When the bit group of O0 to O3 in FIG. 1 is processed with the cln pass, information about the bits represented by x in the ambient group is required. When the group is classified according to the respective bits, information about ambient 8 bits is required for the bits O0, O1, O2 and O3 shown in FIG. 2 to FIG. 5.

The condition that a bit is processed with the cln pass is that the bit is unprocessed. However, since only the process with the cln pass is executed on MSB, all the bits are to be processed. Therefore, the information about as to whether or not the bit to be processed is processed is required.

In addition, when all the bits O0, O1, O2 and O3 shown in FIG. 2 to FIG. 5 are unprocessed with the cln pass, a judgment is made as to whether or not they can be processed collectively. As for the bits O0, O1, O2 and O3 shown in FIG. 2 to FIG. 5, when all the ambient bit group of x0 to Δ7 is insignificant, special context is generated (hereinafter, run length context).

In addition, when all the values of the bits O0, O1, O2 and O3 shown in FIG. 2 to FIG. 5 are zero, decision (hereinafter, run length decision) 0 is generated, and the process on this group is ended.

In addition, when at least one of the values of the bits O0, O1, O2 and O3 shown in FIG. 2 to FIG. 5 is one, the run length decision is 1. At this time, a position of the first bit having the value 1 in the bits O0, O1, O2 and O3 shown in FIG. 2 to FIG. 5 is represented by data of 2 bits.

Namely, when the bit O0 is the first bit having one, the position is 00, when the bit O1, the position is 01 and similarly is 10 and 11. The two data are generated together with a context which follows the run length (hereinafter, UNIFORM context), and they are output as decisions (hereinafter, UNIFORM decision).

When only the run length context is output, all the bits are still insignificant. For this reason, the significance flag are not updated.

When the UNIFORM context is also output, the bit in the position shown by the UNIFORM decision is changed from insignificance to significance. For this reason, the significance flag of the bit is updated.

However, since the UNIFORM context itself shows that the bit in the position shown by the decision is 1. For this reason, similarly to the sig pass, the context of the sign bit of that bit is generated.

The method of generating the context of the sign bit with the cln pass is the same as the sig pass. When the UNIFORM decision is 11, only the process on the sign bit is executed to be ended. However, when the other cases, remaining bits are processed one by one.

The method of processing the remaining bits is the same as the sig pass except that all ambient bits of the bit are processed although they are insignificant. Moreover, since the bits before the position shown by the UNIFORM decision are still insignificant, the significance flag is not updated.

According to the third embodiment, when a group of bits is not to be processed for the run length context, the unprocessed bits in the bits in the group are processed one by one. Moreover, bits after the UNIFORM context or unprocessed bits, which are not to be processed for the run length context, are subject to the same process as the sig pass. For this reason, the same circuit as the sig pass can be configured.

In addition, in the case of using the sig pass, the circuit is configured so as to process the independent bits in parallel and outputs 0 to 8 sets of contexts and decisions. However, according to the cln pass, the circuit processes the context and decision of 0 run length and processes the context and decision of UNIFORM in parallel. Moreover, after the followings are taken into consideration:

in the case of including the 0 run length context

as to whether or not the UNIFORM context is included

a number of bits after the UNIFORM context; and

in the case of non-including the 0 run length context

a number of bits to be processed with the cln pass,

the circuit can be configured so as to calculate the contexts and decisions of 0 run length, UNIFORM and the respective bits and output 0 to 10 sets of contexts and decisions.

The first to third embodiments explained the individual circuit configurations for the respective coding passes. However, in the fourth embodiment, one group in one bit plane is processed simultaneously by the circuits of the first to third embodiments.

In this case, since three kinds of coding passes use information commonly, it is necessary to store significance flag, significance second bit and processed flag for a code block size into a register.

In addition, it is necessary to store sign bit and data bits of a bit plane to be processed for the code block size or for a portion to be processed actually into a register. Moreover, in the case where they are read for each coding pass, it is necessary to store them for the reading into the register.

According to the fourth embodiment, the processing speed can be higher than the first to third embodiments.

FIG. 6 is a diagram showing a range of data to be used in the case where three continued groups are processed according to the fifth embodiment. The fourth embodiment explained the method of processing one group in one bit plane is processed simultaneously with three kinds of coding passes.

However, a certain bit plane in a code block is processed with in the order of the sig pass, the ref pass and the cln pass. Since there exist restrictions such that the respective bits are processed with only one coding pass and the significance flags are updated by a plurality of passes such as the sig pass and the cln pass, in order to obtain the accurate bit modeling, it is necessary to execute the processes with the respective coding passes.

Namely, in a certain bit plane, the four bits are processed simultaneously, but actually they are processed one by one with three kinds of coding passes. As a result, it is necessary to suppress an operating frequency of the circuit. In order to solve this problem, the fifth embodiment adopts the method of processing grooves which continues in the horizontal direction (bit group of O0 to O3, bit group of O4 to O7, bit group of O8 to O11) with different coding passes.

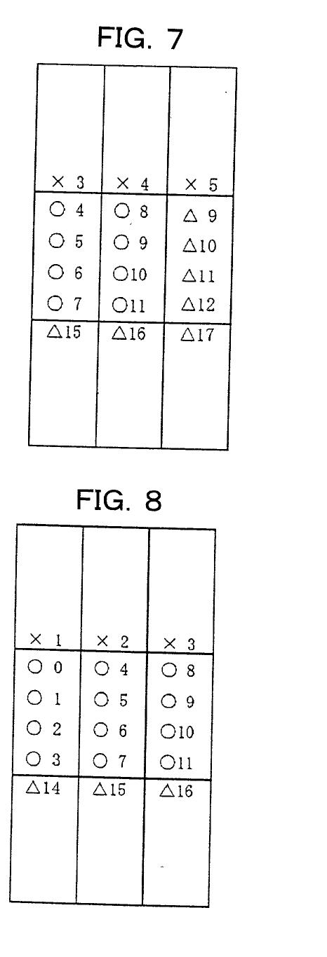

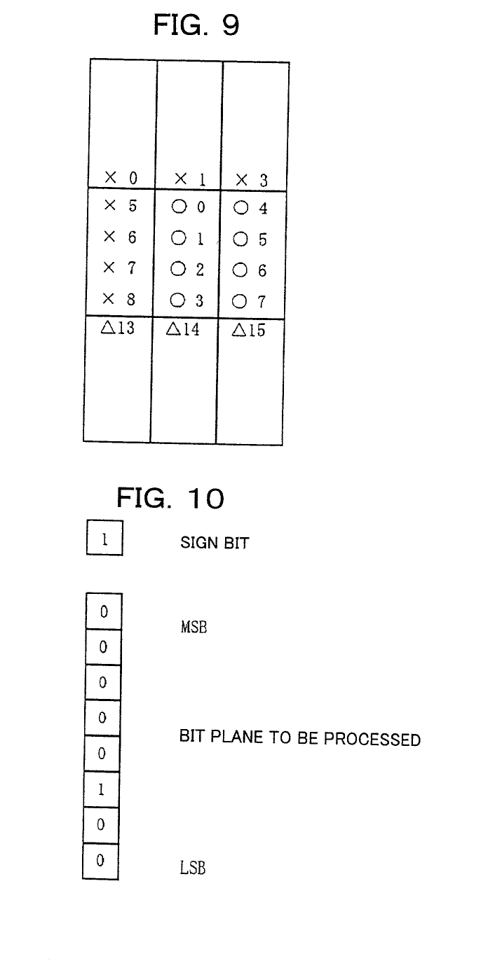

FIG. 7 is a diagram showing a range of data to be used in the case where the bit group of O8 to O11 is processed. Moreover, FIG. 8 is a diagram showing a range of data to be used in the case where the bit group of O4 to O7 is processed. Further, FIG. 9 is a diagram showing a range of data to be used in the case where the bit group of O0 to O3 is processed.

The sig pass is insignificant and is a coding pass used for processing when the ambient bits include one or more significant bits. The process with the sig pass can be first executed without any restriction from the other two passes.

In the three groups shown in FIG. 6, the sig pass is a coding pass for processing the bit group of O8 to O11, and FIG. 7 is the use range of its data. Since the bit group of O8 to O11 is processed with the sig pass, the processed flag and the significance flag of the bit group of O8 to O11 are updated according to the condition.

The bit groups of x5 to x8, the bit group of O0 to O3 and the bit group of O4 to O7 in FIG. 6 to FIG. 9 have been already processed with the sig pass.

Next, since the ref pass is a coding pass for processing significant data, it is necessary to consider as to whether or not the data are significant at the time of the process.

In order to obtain as to whether or not the bit has been already significant, the significance flag is referred to. However, when the bit is processed with the sig pass of the same bit plane to be significant, it cannot be processed.

Namely, since it is necessary to make a judgment as to whether or not the bit is processed with the sig pass, the bit cannot be processed with the ref pass simultaneously with the sig pass.

In the three groups shown in FIG. 6, the ref pass is a coding pass for processing the bit group of O4 to O7, and FIG. 8 is the use range of that data. Since the bit group of O4 to O7 is processed with the ref pass, the processed flag and the significance flag of the bit group of O4 to O7 are referred to so that the unprocessed flag is updated according to the condition.

The bit group of O8 to O11 is processed with the sig pass, and the bit group of O4 to O7 is processed with the ref pass so that the flag of the bit group of O4 to O7 which has been updated with the sig pass can be referred to with the ref pass.

In addition, the fifth embodiment explained the structure that the groups which are processed with the sig pass and the ref pass are shifted by one group in the horizontal direction in order to minimize the circuit scale, but the groups may be shifted by two groups.

The bit group of x5 to x8 and the bit group of O0 to O3 in FIGS. 6, 8 and 9 have been already processed with the ref pass.

In addition, the cln pass is insignificant, and is a coding pass for processing data which have not been processed with the sig pass. In the fifth embodiment, the significant data have been already processed with the ref pass, and the data in insignificant data which have not been processed with the sig pass are all unprocessed data. For this reason, the processed flag is referred to, and only the unprocessed data are processed.

Since it is necessary to refer to the significance flags of the bit to be processed and the ambient bits, the data cannot be processed with the cln pass simultaneously with the sig pass.

In the three groups shown in FIG. 6, the cln pass is a coding pass for processing the bit group of O0 to O3, and FIG. 9 shows a use range of its data. Since the bit group of O0 to O3 is processed with the cln pass, the significance flag of the bit groups of O4 to O7 and the processed flag of the bit group of O0 to O3 are referred to, and the significance flag is updated according to the condition.

In addition, the bit group of x5 to x8 in FIGS. 6 and 9 have been already processed with the cln pass.

The bit group of O8 to O11 is processed with the sig pass, and the bit group of O4 to O7 is processed with the ref pass, and the bit group of O0 to O3 is processed with the cln pass. As a result, the flags of the bit group of O0 to O3 and the bit group of O4 to O7, which have been updated with the sig pass and the ref pass, can be referred to with the cln pass.

In addition, the fifth embodiment explained the structure that the groups to be processed with the sig pass and the ref pass are shifted by one group in the horizontal direction in order to minimize the circuit scale. However, a number of groups to be processed with the sig pass, the ref pass and the cln pass may be arbitrary.

When the processes with three kinds of coding passes are executed in parallel in the above structure, four data can be processed in parallel with three kinds of coding passes by the same method as the first to fourth embodiments.

In addition, in FIG. 6, the bit group of Δ9 to Δ12 is processed with the sig pass, the bit group of O8 to O11 is processed with the ref pass, and the bit group of O4 to O7 is processed with the cln pass. Namely, the groups to be processed are shifted so that the processes can be executed continuously.

The respective coding passes output 0 to 10 sets of contexts and decisions, but it is necessary to store these data for each coding pass.

According to the fifth embodiment, it is necessary to store the significance flags and the significance second bit information for the code block size into the register. However, since the processes with three kinds of the coding passes are executed at the same time, only parts of the sign bits, the data bit of the bit plane to be processed, and the processed flag which is to be processed actually may be stored in the register.

In addition, as shown in FIG. 6, in the case where intervals of the groups to be processed with the respective coding passes are one group, a portion to be processed becomes 30 bits of O, Δ and x with sign bits, or 20 bits of x5 to x8 and O0 to O11 and Δ9 to Δ12 with data bits and processed flag.

Therefore, in comparison with the first to fourth embodiments, the processes can be executed at higher speed and the circuit scale can be reduced.

There will be explained below the parallel processing method according to a sixth embodiment. This is a method of processing portions where the significance flags and the significance second bits in FIG. 6 are to be processed (30 bits of O, Δ and x (significance flag), 20 bits of x5 to x8, O0 to O11 and Δ9 to Δ12 (significance second bit)) with a register amount.

The significance flag is required for a code block size because while the bit modeling from MSB to LSB is being carried out, since information should be used commonly, it is necessary to hold the information.

However, in the process on a certain bit plane, the state after the process on the previous bit plane may be understood. Therefore, if the state after the process on the previous bit plane can be previously calculated, it is not necessary to use the information commonly between the bit planes.

The sixth embodiment adopts a method of checking a value of data to be processed, and making a judgment as to whether or not a bit, a value of which is 1, exists in higher position than a bit plane to be processed.

FIG. 10 is a diagram showing values of one datum to be processed with bit modeling divided into a sign bit and absolute values. With reference to FIG. 10, since all values from MSB to the bit one higher than a certain bit plane to be processed are zero, the significance flag of the data before the process with the sig pass is insignificant.

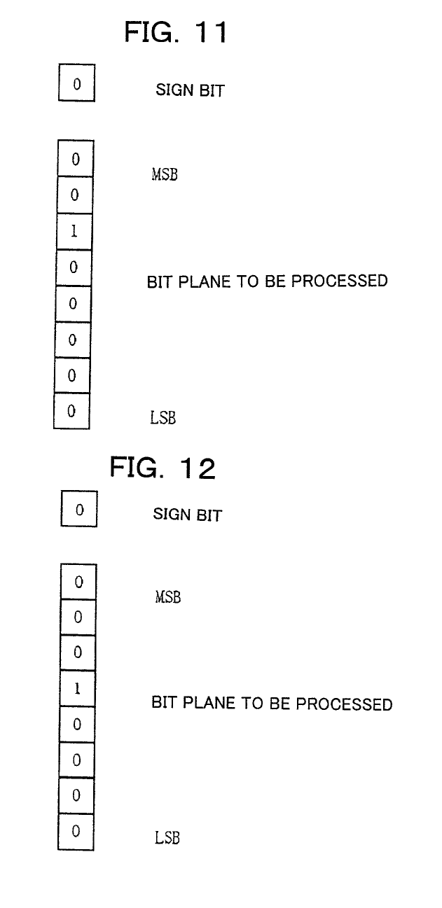

In addition, in FIG. 11, since the values from MSB to the bit one higher than the bit plane to be processed are 1, the significance flag of the data before the process with the sig pass is significant.

If this is executed when data bits are read for each bit plane, it is not necessary to use information commonly between the bit planes. For this reason, a number of registers for the significance flags can be reduced.

Therefore, the significance flags may have a number of registers for 30 bits of O, Δ and x in FIG. 6.

In addition, similarly as for the significance second bits, a bit plane to be processed with the ref pass at the first time, namely, a bit plane which is next to a significant bit plane is previously calculated so that it is not necessary to use information commonly between bit planes.

In the sixth embodiment, data to be processed are checked, and a judgment is made as to whether or not the value one bit higher than the bit plane to be processed is 1 and all the bits higher than the value are 0.

With reference to FIG. 10, since all the values of the bits higher than the bit plane to be processed are 0, they do not become the significance second bits. Moreover, in FIG. 11, since the value of the bit one higher than the bit plane to be processed is 1 and all the values of the higher bits than the value are 0, they become the significant second bits.

This is executed when the data bits are read for each bit plane so that it is not necessary to use information commonly between bit planes. For this reason, a number of registers of the significant second bits can be reduced.

Therefore, the significant second bits may have registers for 20 bits of x5 to x8, O0 to O11, Δ9 to Δ12 shown in FIG. 6.

In the sixth embodiment, the circuit, which executes the processes with three kinds of coding passes in parallel on one bit plane, and this circuit is a basic circuit of the following embodiments.

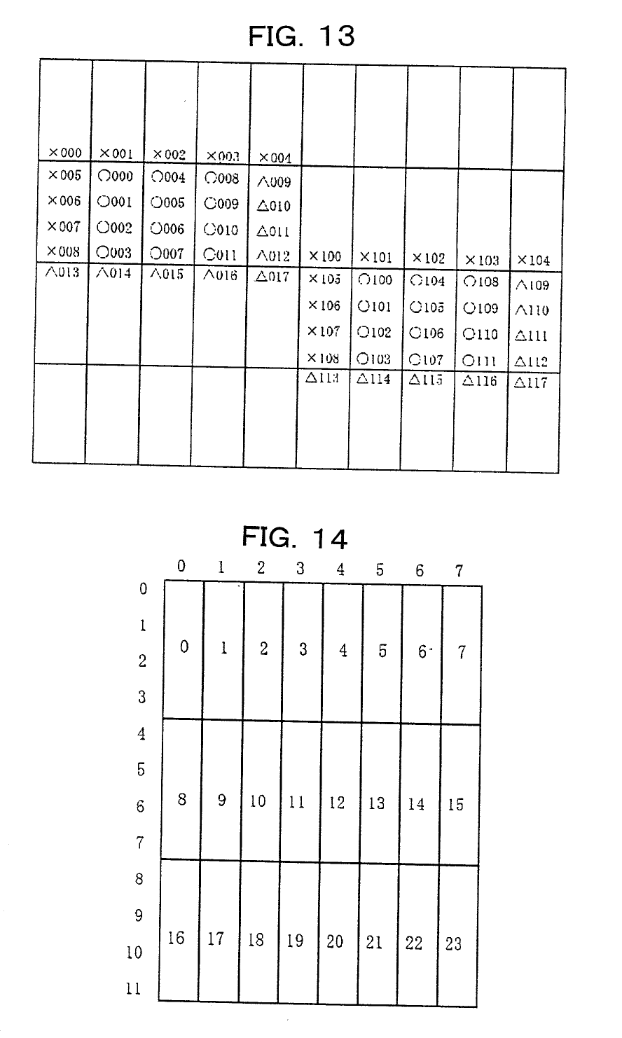

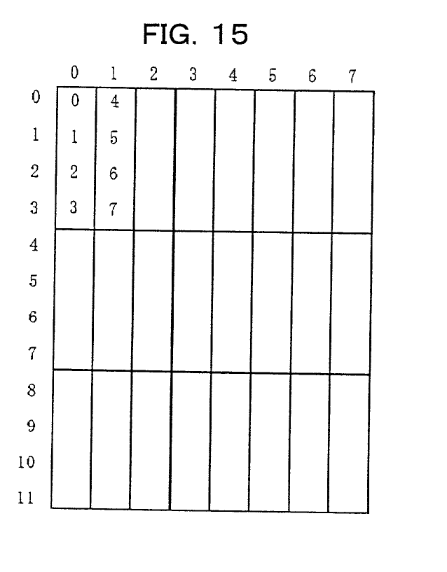

The seventh embodiment adopts a processing method using a plurality of circuits of the sixth embodiment for one bit plane. FIG. 13 is a diagram showing a range of data to be used in the case where three continued groups are processed in parallel. This uses the two circuits explained in the sixth embodiment for the bit groups of O000 to O011 and O100 to O111.

With reference to FIG. 13, the same circuit as the sixth embodiment is used for the bit group of O000 to O011 so as to directly process them. Moreover, since the bit group of x100 to x104 are data which are originally processed before the bit group of O100 to O111, it is necessary to previously calculate significance flags.

The sixth embodiment explained the method of calculating the significance flag up to the bit plane one bit higher than the bit plane to be processed. However, in the seventh embodiment, information after a process of a group one step upper in the vertical direction is required. This can be calculated by taking data of the bit plane to be processed as well as the method in the sixth embodiment into consideration.

There will be explained below the case where x100 shown in FIG. 13 has the values shown in FIG. 10 to FIG. 12.

In FIG. 10, since all the values from MSB to the bit plane to be processed are zero, the significance flag is insignificant. In FIG. 11, since there is a bit having the value of 1 from MSB to one bit higher than the bit plane to be processed, x100 is significant.

In addition, in FIG. 12, since there is a bit having the value of 1 from MSB to the bit plane to be processed (in this case, bit plane to be processed), x100 is significant. In such a manner, the significance flag of up to the group one-stage higher in the vertical direction can be calculated.

However, the same processes as the first to sixth embodiments are executed on the bit group of x105 to x108 and the bit group of Δ109 to Δ117. For example, the bit Δ117 has the value shown in FIG. 12, it becomes insignificant.

According to the seventh embodiment, the parallel processes can be executed on a plurality of groups in one bit planes. Moreover, the seventh embodiment explained the example that the groups which continue in the vertical direction are processed, but intervals of the groups in the vertical direction are not limited to land maybe arbitrary. A number of the circuits similar to the sixth embodiment which execute the processes in parallel may be arbitrary number of not less than two. Here, when two parallel circuits are provided, the circuit scale is doubled, and the processing performance is also doubled.

Further, there will be explained below the method of executing the processes on different bit planes in parallel in the eighth embodiment (not shown). This parallel processes can be executed on a plurality of bit planes (arbitrary number of not less than two) by simultaneously using the method explained in the sixth embodiment for different bit planes.

In addition, in the eighth embodiment, when two parallel circuits are provided, the circuit scale is doubled, and the processing performance is also doubled.

Further, the same circuit as the seventh embodiment can be simultaneously used for different bit planes. In this case, an arbitrary number of bit planes can be processed in parallel.

As for a processing method of JPEG 2000 bit modeling and a processing circuit using the method according to the present invention, in a processing method with a significance propagation decoding pass, the processing circuit of the bit modeling is simultaneously applied to four bits of one group and processes the four bits in parallel so that the processing speed can be heightened. The processing circuit simultaneously generates a context and a decision of data changing according to a state of significance flags of a bit to be processed and an ambient bit group, and a context and a decision of sign bits changing according to a state of the sign bits of the bit to be processed and the ambient bit group, and adopts the context and the decision of the sign bits only when the value of the bit to be processed is 1 so as to update the significance flags, disposes of the context and the decision when the value of the bit to be processed is 0, and updates processed flag whether the value of the bit to be processed is 1 or 0.

In addition, in a processing method of JPEG 2000 bit modeling with magnitude refinement pass, the processing circuit of bit modeling is simultaneously applied to four bits in one group and processes the four bits in parallel so that the processing speed can be further heightened. The processing circuit refers to a significance second bit which is information about as to whether or not the bit to be processed is processed with the magnitude refinement pass at the first time, the processed flag and the significance flag so as to make a judgment as to whether or not the bit is processed, and generates a context and a decision of the bit to be processed in the case where the bit is processed with the magnitude refinement pass, and updates the processed flag.

In addition, in a processing method of bit modeling with JPEG 2000 cleanup pass, a first processing circuit of bit modeling and a second processing circuit of bit modeling are provided and simultaneously applied to one bit and four bits in one group and process the bits in parallel so that the processing speed can be further heightened. The first processing circuit, when all bits in a group to be processed are unprocessed, makes a judgment as to whether or not they can be processed collectively, and when all the bits in one group are insignificant, generates special context and decision. The second processing circuit does not process processed bits, and processes insignificant bits.

In addition, in the processing method of JPEG 2000 bit modeling, since one bit plane is processed with three kinds of the coding passes successively, the processing speed can be further heightened.

In addition, in the processing method of JPEG 2000 bit modeling, since adjacent three groups in one bit plane are processed in parallel with three kinds of the coding passes, the processing speed can be further heightened, and the circuit scale can be reduced.

In addition, in the processing method of bit modeling from a fifth aspect, since a plurality of bits in one bit plane are processed in parallel, the processing speed can be further heightened, and the circuit scale can be reduced.

Further, in the processing method of bit modeling from fifth or sixth aspect, since a plurality of bit planes are processed in parallel, the processing speed can be further heightened.

In addition, in the processing circuit using the processing method bit modeling from a first aspect, a register which stores a value of data of a certain bit to be processed, a register which stores the significance flags and sign bits of the bit to be processed and the ambient bit group, and a register which stores the processed flag of the bit to be processed are provided. As a result, the processing speed can be heightened.

In addition, in the processing circuit using the method of performing bit modeling from a second aspect, a register which stores a value of data of a certain bit to be processed, a register which stores significance flags of the bit to be processed and the ambient bit group, and a register which stores a significance second bit which is information about as to whether or not the bit to be processed is processed at first time with the magnitude refinement pass are provided. As a result, the processing speed can be further heightened.

In addition, in the processing circuit using the method of performing bit modeling from fifth to, sixth or eighth aspect, registers which stores data bits, sign bits, processed flags and significance flags and significance second bits for code block size are provided. As a result, the processing speed can be heightened, and the circuit scale can be reduced.

Further, in the processing circuit using the method of performing bit modeling from the fifth, sixth or eighth aspect, registers which stores data bit, sign bit, processed flag, significance flag and significance second bit for the bit to be processed are provided. As a result, the processing speed can be further heightened, and the circuit scale can be reduced.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A processing method of JPEG 2000 bit modeling with a significance propagation decoding pass, wherein a processing circuit of bit modeling is simultaneously applied to four bits in one group and processes the four bits in parallel, said processing circuit simultaneously generating a context and a decision of data changing according to a state of significance flags of a bit to be processed and ambient bit group and a context and a decision of sign bits changing according to a state of the sign bits of the bit to be processed and the ambient bit group; adopting the context and decision of the sign bits only when a value of the bit to be processed is 1 and updating the significance flag; disposing of the context and the decision when the value of the bit to be processed is 0; and updating a processed flag whether the value of the bit to be processed is 1 or 0.

2. The processing method according to claim 1, said processing circuit comprising:
a register which stores a value of data of a bit to be processed;
a register which stores significance flags and sign bits of the bit to be processed and ambient bit group; and
a register which stores an unprocessed flag of the bit to be processed.

3. A processing method of JPEG 2000 bit modeling with a magnitude refinement pass, wherein a processing circuit of the bit modeling is simultaneously applied to four bits in one group and processes the four bits in parallel, said processing circuit referring to significance second bit which is information about as to whether or not a bit to be processed is processed with the magnitude refinement pass at first time, a processed flag and an significance flag so as to make a judgment as to whether or not the bit to be processed is processed; and in the case where the bit to be processed is processed with the magnitude refinement pass, generating a context and a decision of the bit so as to update the processed flag.

4. The processing method according to claim 3, said processing circuit comprising:
a register which stores a value of data of a bit to be processed;
a register which stores significance flags of the bit to be processed and ambient bit group; and
a register which stores a significance second bit which is information about as to whether or not the bit to be processed is processed with the magnitude refinement pass at the first time.

5. A processing method of JPEG 2000 bit modeling with a cleanup pass, wherein a first processing circuit of the bit modeling for, when all bits in Annie group to be processed are unprocessed, makes a judgment as to whether or not the bits can be processed collectively and when all the bits in the group are insignificant, generating a special context and a decision; and a second circuit of the bit modeling for not processing processed bits and processing insignificant bits are provided, and said first processing circuit is applied to one bit and said second processing circuit is applied to four bits in the group simultaneously so as to process the bits in parallel.

6. A processing method of JPEG 2000 bit modeling comprising:
a step of processing a significance propagation decoding pass, wherein a first processing circuit of bit modeling is simultaneously applied to four bits in one group and processes the four bits in parallel, said first processing circuit simultaneously generating a context and a decision of data changing according to a state of significance flags of a bit to be processed and ambient bit group and a context and a decision of sign bits changing according to a state of the sign bits of the bit to be processed and the ambient bit group; adopting the context and decision of the sign bits only when a value of the bit to be processed is 1 and updating the significance flag; disposing off the context and the decision when the value of the bit to be processed is 0; and updating a processed flag whether the value of the bit to be processed is 1 or 0;
a step of processing a magnitude refinement pass, wherein a second processing circuit of the bit modeling is simultaneously applied to four bits in one group and processes the four bits in parallel, said second-processing circuit referring to significance second bit which is information about as to whether or not a bit to be processed is processed with the magnitude refinement pass at first time, a processed flag and an significance flag so as to make a judgment as to whether or not the bit to be processed is processed; and when the bit to be processed is processed with the magnitude refinement pass, generating a context and a decision of the bit so as to update the processed flag; and
a step of processing a cleanup pass, wherein a third processing circuit of the bit modeling, when all bits in Annie group to be processed are unprocessed, makes a judgment as to whether or not the bits can be processed collectively and when all the bits in the group are insignificant, generating a special context and a decision, and does not process processed bits and processes insignificant bits, and wherein one bit when processing all the bits collectively and four bits when processing the bits in the same group are processed simultaneously and in parallel,
wherein, when the bit plane is same, then the significance propagation decoding pass, the magnitude refinement pass, and the cleanup pass are processed successively.

7. A processing method of JPEG 2000 bit modeling comprising:
a step of processing a significance propagation decoding pass, wherein a first processing circuit of bit modeling is simultaneously applied to four bits in one group and processes the four bits in parallel, said first processing circuit simultaneously generating a context and a decision of data changing according to a state of significance flags of a bit to be processed and ambient bit group and a context and a decision of sign bits changing according to a state of the sign bits of the bit to be processed and the ambient bit group; adopting the context and decision of the sign bits only when a value of the bit to be processed is 1 and updating the significance flag; disposing off the context and the decision when the value of the bit to be processed is 0; and updating a processed flag whether the value of the bit to be processed is 1 or 0;
a step of processing a magnitude refinement pass, wherein a second processing circuit of the bit modeling is simultaneously applied to four bits in one group and processes the four bits in parallel, said second processing circuit referring to significance second bit which is information about as to whether or not a bit to be processed is processed with the magnitude refinement pass at first time, a processed flag and an significance flag so as to make a judgment as to whether or not the bit to be processed is processed; and when the bit to be processed is processed with the magnitude refinement pass, generating a context and a decision of the bit so as to update the processed flag; and
a step of processing a cleanup pass, wherein a third processing circuit of the bit modeling, when all bits in Annie group to be processed are unprocessed, makes a judgment as to whether or not the bits can be processed collectively and when all the bits in the group are insignificant, generating a special context and a decision, and does not process processed bits and processes-insignificant bits, and wherein one bit when processing all the bits collectively and four bits when processing the bits in the same group are processed simultaneously and in parallel,
wherein, when the bit plane is same, three adjacent groups in said bit plane are processed in parallel for each of the significance propagation decoding pass, the magnitude refinement pass, and the cleanup pass.

8. The processing method according to claim 7, processing a plurality of bits in the bit plane in parallel.

9. The processing method according to claim 7, processing a plurality of bit planes in parallel.

10. The processing method according to claim 7, said processing circuit further comprising a register which stores data bits, sign bits, processed flags, significance flags and significance second bits for a code block size.

11. The processing method according to claim 7, each of said first, second, and third processing circuit further comprising a register which stores a data bit, a sign bit, a processed flag, a significance flag and a significance second bit for a bit to be processed.
